(19) United States
(12) Patent Application Publication
(10) Pub. No.: US 2014/0327297 A1
(43) Pub. Date: Nov. 6, 2014

(54) BRAKE SYSTEM FOR A VEHICLE AND METHOD FOR OPERATING A BRAKE SYSTEM OF A VEHICLE

(71) Applicants: Frank Kaestner, Bietigheim-Bissingen (DE); Rene Schepp, Waiblingen (DE); Norbert Alaze, Markgroeningen (DE); Daniel Gosse, Berlin (DE)

(72) Inventors: Frank Kaestner, Bietigheim-Bissingen (DE); Rene Schepp, Waiblingen (DE); Norbert Alaze, Markgroeningen (DE); Daniel Gosse, Berlin (DE)

(21) Appl. No.: 14/235,199

(22) PCT Filed: May 29, 2012
(86) PCT No.: PCT/EP2012/060034

§ 371 Date: Jun. 4, 2014

(30) Foreign Application Priority Data
Jul. 26, 2011 (DE) 10 2011 079 860.9

(51) Int. Cl. B60T 13/14; B60T 8/48; B60T 1/06

(52) U.S. Cl. CPC B60T 13/14; B60T 13/147; B60T 1/065; B60T 8/489
USPC 303/116.1

(57) ABSTRACT

A brake system for a vehicle, including a brake master cylinder that is hydraulically connected to at least one wheel brake caliper; and a fluid delivery device by which brake fluid is transferable into the at least one wheel brake caliper, the fluid delivery device being embodied as a substantially uniformly delivering pump device by which brake fluid is pumpable out of a fluid reservoir device into the at least one wheel brake caliper. The fluid delivery device can be, a gear pump or a phase-shifted multi-piston pump. A method for operating a brake system of a vehicle is also described.

### FIELD

The present invention relates to a brake system for a vehicle. The present invention furthermore relates to a method for operating a brake system of a vehicle.

### BACKGROUND INFORMATION

European Patent No. EP 0 056 515 A1 describes a plunger apparatus embodied as an anti-slip regulation system. By way of the anti-slip regulation system, a volume of brake fluid can be drawn in from a wheel brake caliper into a fluid reservoir volume of the anti-slip regulation system in order to reduce a brake pressure in the wheel brake caliper. Similarly, a volume of brake fluid can be forced out of the fluid reservoir volume of the anti-slip regulation system into the wheel brake caliper in order to increase the brake pressure.

### SUMMARY

In accordance with the present invention, a fluid delivery device embodied as a substantially uniformly delivering pump device has an advantageous capability for increasing the brake pressure in at least one wheel brake caliper independently of an internal pressure in a brake master cylinder. Be it noted, however, that the present invention described hereinafter is not limited to this use.

“Simultaneous delivery” can be understood as a delivery not having a pronounced pressure maximum for each cycle or operating period of the pump device. The use of the fluid delivery device embodied as a substantially uniformly delivering pump device makes it possible to prevent operation of the fluid delivery device from causing vibration or jittering of a brake actuation element, such as in particular a brake pedal, actuated by a driver.

The energy consumption of the fluid delivery device embodied as a substantially uniformly delivering pump device is comparatively low thanks to the elimination of friction losses that occur, for example, in the context of a plunger. In accordance with the present invention, a reduction in energy consumption and in emission may be ensured. In addition, a substantially uniformly delivering pump device does not require the comparatively large conversion ratio of a plunger.

The fluid delivery device is preferably embodied as a gear pump or as a phase-shifted multi-piston pump. The fluid delivery device embodied as a gear pump or as a phase-shifted multi-piston pump can be installed with decreased installation outlay, has a reduced overall size, and can be manufactured at lower cost. The energy consumption of the fluid delivery device embodied as a gear pump or as a phase-shifted multi-piston pump is relatively low due to the elimination of friction losses. In addition, a gear pump or a phase-shifted multi-piston pump requires only a comparatively low conversion ratio.

In an advantageous embodiment, the at least one wheel brake caliper is hydraulically connected via a blending valve to the fluid reservoir device, in such a way that brake fluid is transferable into the fluid reservoir device via the blending valve that is controlled into an at least partly opened state. In this case the advantageous refinement not only is designed to increase a brake pressure in the at least one wheel brake caliper, but also can be used to reduce the brake pressure in the at least one wheel brake caliper.

The fluid delivery device embodied as a substantially uniformly delivering pump device, and the blending valve, are economical components for a hydraulic regeneration unit or regeneration device. As compared with a plunger, the regeneration unit assembled from these components does not need a complex gearing system such as, for example, a spindle gearing system. In addition, the fluid delivery device embodied as a substantially uniformly delivering pump device and the blending valve can be embodied on a brake system by way of an easily executable assembly operation reduced to conventional method steps. The fluid delivery device embodied as a substantially uniformly delivering pump device and the blending valve can moreover be manufactured economically at a comparatively small size. In particular, subassemblies that are in series production can be used to manufacture the hydraulic regeneration unit assembled from these components.

Optionally, a first check valve can be disposed between the blending valve and the fluid reservoir device. It is thereby possible to ensure, if desired, that even though the blending valve is in an at least partly opened state, brake fluid is transferred into the fluid reservoir device only above a specific brake pressure in the at least one wheel brake caliper.

In addition, a delivery side of the fluid delivery device embodied as a substantially uniformly delivering pump device can be hydraulically connected to the at least one wheel brake caliper via a second check valve. It is thereby possible to reliably prevent brake fluid from infiltrating into the reservoir chamber via the fluid delivery device embodied as a substantially uniformly delivering pump device even though the blending valve is in a closed state.

The fluid delivery device embodied as a gear pump can be, for example, an internal gear pump. This makes possible an economical embodiment, requiring little installation space, of the fluid delivery device. Instead of an internal gear pump, however, an external gear pump is also usable as a fluid delivery device.

In a further advantageous embodiment, the fluid delivery device is a springless reservoir chamber. A “springless reservoir chamber” can be understood, for example, as a reservoir chamber that is not spring-loaded. The use of a springless reservoir chamber allows the brake pressure in the at least one wheel brake caliper to be reduced (almost) to zero.

The fluid delivery device can also be connected via a connecting line to a brake fluid reservoir. This, too, advantageously ensures that the brake pressure in the at least one wheel brake caliper can be reduced to a value of (almost) zero. As discussed in more detail below, thanks to a brake pressure reduced in this manner, at least one vehicle battery can be recharged comparatively quickly with the use of a generator.

The fluid reservoir device is preferably a non-gas-preloaded membrane reservoir. It is thereby possible to prevent the occurrence, in the context of pumping of the previously received brake fluid into the at least one wheel brake caliper, of a negative pressure on the suction side of the fluid delivery device, which pulls a reservoir chamber piston out to the end stop.

The advantages described in the paragraphs above are also ensured in the context of a corresponding method for operating a brake system of a vehicle.

### BRIEF DESCRIPTION OF THE DRAWINGS

Further features and advantages of the present invention are explained below with reference to the Figures.

FIG. 1 schematically depicts a first embodiment of the brake system.

FIG. 2 schematically depicts a second embodiment of the brake system.

FIG. 3 is a flow chart depicting a first embodiment of the method for operating a brake system of a vehicle.

FIGS. 4a to 4c show three coordinate systems to explain a second embodiment of the method for operating a brake system of a vehicle.

### DETAILED DESCRIPTION OF EXAMPLE EMBODIMENTS

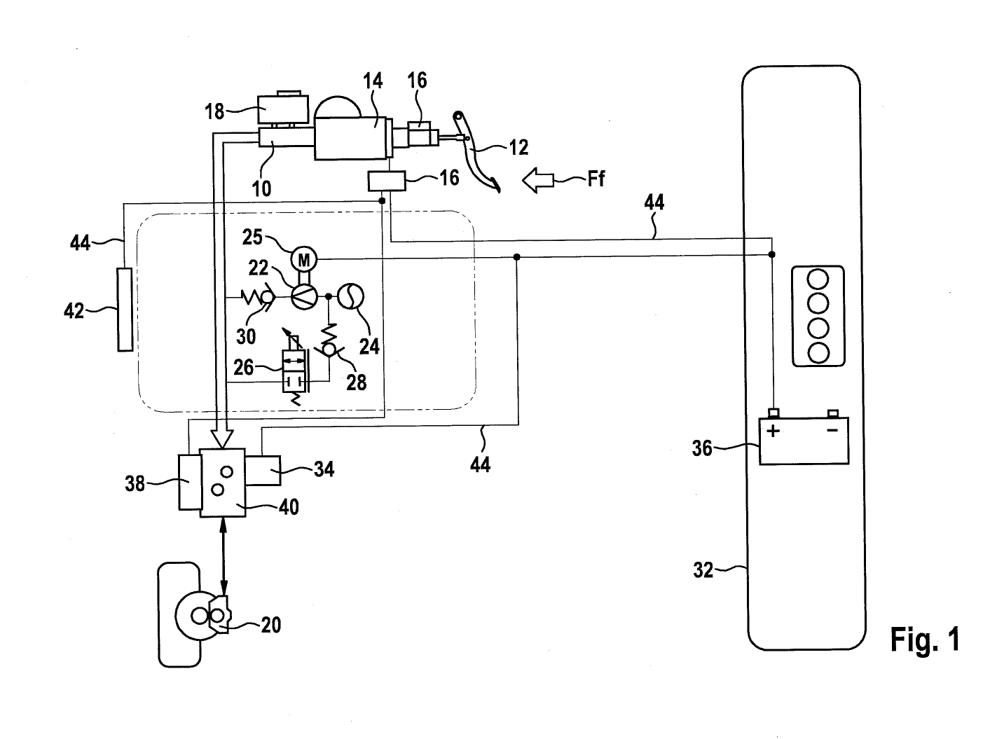

FIG. 1 schematically depicts a first embodiment of the present invention.

The brake system schematically shown in FIG. 1 encompasses a brake master cylinder 10 that is embodied, for example, as a tandem brake master cylinder. The brake system for a motor vehicle which is described hereinafter is not limited, however, to being equipped with a brake master cylinder 10 embodied as a tandem brake master cylinder.

A brake actuation element 12 is preferably disposed on brake master cylinder 10 in such a way that a driver of a vehicle equipped with the brake system can, by way of a driver braking force Ff applied onto brake actuation element 12, displace at least one displaceable piston of brake master cylinder 10, for example a plunger piston and/or a floating piston, at least partly thereinto. Brake actuation element 12 can be embodied in particular as a brake pedal. The brake system described hereinafter is not limited, however, to being equipped with a brake actuation element 12 embodied as a brake pedal, or to being equipped with brake actuation element 12.

The brake system optionally also has a brake booster 14 which is designed, upon an actuation of brake actuation element 12, to exert an additional assisting force (in addition to driver braking force Ff) onto the at least one displaceable piston of brake master cylinder 10. The amount of force to be applied by the driver upon deceleration of the vehicle can thereby be reduced. Brake booster 14 can be, for example, a hydraulic brake booster and/or an electromechanical brake booster. Advantageously, brake booster 14 is embodied as a continuously regulatable or controllable brake booster. The embodiment latitude of brake booster 14 is not, however, limited to the examples listed here.

The brake system can also encompass at least one sensor 16 that is designed to ascertain an actuation intensity of the actuation of brake actuation element 12 by the driver, and to output a corresponding sensor signal. The at least one sensor 16 can be designed, for example, to ascertain the driver braking force Ff, a displacement travel of brake actuation element 12, and/or a brake pressure. The at least one sensor 16 can be, in particular, a piston travel sensor or a brake pressure sensor. The embodiment latitude of the at least one sensor 16 is not, however, limited to the examples described here.

A brake fluid reservoir 18 can also be disposed on brake master cylinder 10. Brake fluid reservoir 18 can be (hydraulically) connected to brake master cylinder 10 in particular via at least one fluid exchange opening, for example a breather orifice. Brake fluid reservoir 18 is preferably embodied so that atmospheric pressure is (constantly) present in brake fluid reservoir 18 independently of an internal pressure in brake master cylinder 10.

Brake master cylinder 10 is hydraulically connected to at least one wheel brake caliper 20. Being “hydraulically connected” can be understood to mean that a brake fluid transfer between the two components hydraulically connected to one another is ensured (at least when at least one valve, possibly disposed therebetween, is in a specific state). A “hydraulic connection” of brake master cylinder 10 to the at least one wheel brake caliper 20 can be understood in particular to mean that the driver can transfer brake fluid out of brake master cylinder 10 into the at least one wheel brake caliper by an at least partial displacement of the at least one displaceable piston into brake master cylinder 10. The driver can thus, by way of an actuation of brake actuation element 12, build up a brake pressure in the at least one wheel brake caliper 20 in order to exert a hydraulic braking torque on the at least one associated wheel.

The brake system can have, in particular, four wheel brake calipers 20 that are each associated with one wheel of the vehicle. Be it noted, however, that the brake system described here is not limited to being equipped with a specific number of wheel brake calipers. The brake system can thus also be embodied to decelerate a vehicle having more than four wheels. The brake system also has a fluid delivery device by which brake fluid is transferable into the at least one wheel brake caliper 20. Fluid delivery device 22 is embodied as a substantially uniformly delivering pump device by which brake fluid is pumpable out of a fluid reservoir device 24 into the at least one wheel brake caliper 20. A “delivering pump device” can be understood in particular as a gear pump and a phase-shifted multi-piston pump. Fluid delivery device 22 can in particular be an internal gear pump. The phase-shifted multi-piston pump can likewise be a pump device embodied from multiple piston pump units, the suction sides of the multiple piston pump units being disposed on one common supply line segment and the delivery sides of the multiple piston pump units being disposed on one common outflow line segment, and a control system of the pump device applying control to the multiple piston pump units in such a way that the phases of the piston pump units are different in the context of operation of the pump device. A phase-shifted multi-piston pump of this kind does not have a pronounced pressure maximum for each cycle or operating period of the delivered flow, but instead has at most several mild and imperceptible or hardly perceptible “pressure maxima” that nevertheless do not disrupt (substantially) uniform delivery.

Fluid delivery device 22 is hydraulically connected on its suction side to fluid reservoir device 24. Fluid delivery device 22 is likewise hydraulically connected on its delivery side to the at least one wheel brake caliper 20, in such a way that brake fluid is pumpable by way of fluid delivery device 22 out of fluid reservoir device 24 into the at least one wheel brake caliper 20. This can also be brought about if at least one valve (not shown) is also disposed between fluid delivery device 22 and the at least one wheel brake caliper 20.

In addition to the brake fluid transferred out of brake master cylinder 10, further brake fluid can thus be pumped by fluid delivery device 22 into the at least one wheel brake caliper 20. Because the brake system is equipped with fluid delivery device 22, the brake pressure in the at least one wheel brake caliper can therefore be increased above the brake pressure built up by way of the driver braking force Ff. This can be utilized, for example, for faster braking of the vehicle. A further capability for using fluid delivery device 22 to blend in a generator braking torque is discussed in more detail below.

The embodiment of fluid delivery device 22 as a substantially uniformly delivering pump device (gear pump or phase-shifted multi-piston pump) allows pulsations upon the transfer brake fluid out of fluid reservoir device 24 into the at least one wheel brake caliper 20 to be kept low or small. It is thereby possible to prevent the driver from perceiving, upon an actuation of brake actuation element 12, vibrations or jittering of brake actuation element 12 caused by large pulsations. The reduction or prevention of pulsations upon the transfer of brake fluid from fluid reservoir device 24 into the at least one wheel brake caliper 20 by way of fluid delivery device 22 embodied as a substantially uniformly delivering pump device (gear pump or phase-shifted multi-piston pump) allows a pleasant brake actuation feel to be achieved for the driver.

Furthermore, the use of fluid delivery device 22 embodied as a gear pump or as a phase-shifted multi-piston pump allows an appreciable reduction in torque irregularities, with the result that solid-borne sound can be reduced. Fluid delivery device 22 and fluid reservoir device 24 moreover have an overall size appreciably reduced as compared with a plunger. Fluid delivery device 22 embodied as a gear pump or as a phase-shifted multi-piston pump is moreover operable without frictional loss, which is a further advantage over a plunger. The use, instead of a plunger, of fluid delivery device 22 embodied as a gear pump or as a phase-shifted multi-piston pump thus allows a reduction in the energy consumption and pollutant emissions of the vehicle equipped with the brake system. A fluid delivery device 22 embodied as a gear pump or as a phase-shifted multi-piston pump furthermore does not require a complex gearing system, so that as a rule it can be manufactured more economically than a plunger.

Fluid delivery device 22 embodied as a gear pump or as a phase-shifted multi-piston pump can be operated using an economical pump motor 25. A pump motor 25 taking up less installation space can also be used for fluid delivery device 22.

Fluid reservoir device 24 can be a reservoir chamber, in particular a springless reservoir chamber. A springless embodiment of the reservoir chamber allows an additional return spring on the reservoir piston to be omitted. The embodiment of fluid reservoir device 24 as a springless/non-spring-loaded reservoir (spring-unloaded reservoir) is furthermore associated with a further advantage: with a spring-loaded embodiment of fluid reservoir device 24, the internal pressure in fluid reservoir device 24 can assume a value appreciably different from zero depending on the piston position and spring preload. Because of this nonzero internal pressure in fluid reservoir device 24, in this case the brake pressure in the at least one wheel brake caliper can be released or reduced only to that corresponding value. An embodiment of fluid reservoir device 24 as a non-spring-loaded reservoir is thus associated with the advantage that the pressure in the at least one wheel brake caliper 20 can be reduced (almost) to zero. The springless embodiment of the reservoir chamber thus permits the brake pressure in the at least one wheel brake caliper 20 to be reduced to a value of (almost) zero.

A further particularly advantageous embodiment of fluid reservoir device 24 is discussed in more detail below. Fluid reservoir device 24 can be designed, for example, for a reservoir volume of between 2 and 5 cm³, in particular between 3 and 3.5 cm³. A space-saving component can thus also be used for fluid reservoir device 24.

In a preferred embodiment, the at least one wheel brake caliper 20 is hydraulically connected via a blending valve 26 to fluid reservoir device 24, in such a way that brake fluid is transferable into fluid reservoir device 24 via blending valve 26 that is controlled into an at least partly opened state. The brake pressure in the at least one wheel brake caliper 20 can thereby be reduced. Blending valve 26 is preferably embodied as a valve that is closed when unenergized. Because energization of blending valve 26 in this case is necessary only in order to control blending valve 26 into the at least partly opened state, energy can be saved by embodying blending valve 26 to be closed when unenergized.

Be it noted that “blending valve” 26 is not to be understood as a wheel outlet valve. Instead, the at least one brake circuit of the brake system can encompass one wheel outlet valve per wheel brake caliper, and additionally blending valve 26.

Optionally, a first check valve 28 can be disposed between blending valve 26 and fluid reservoir device 24. First check valve 28 can be embodied, for example, for a first opening pressure that is comparatively low. The first opening pressure can be, for example, below 1 bar, advantageously below 0.5 bar, in particular can be 0.1 bar. Be it noted, however, that the embodiment latitude of the brake system is not limited to being equipped with a first check valve 28, or to the latter being equipped for a specific first opening pressure.

The delivery side of fluid delivery device 22 embodied as a substantially uniformly delivering pump device can be connected via a second check valve 30 to the at least one wheel brake caliper 20 and/or to brake master cylinder 10. By equipping the brake system with second check valve 30 it is possible to reliably prevent undesired infiltration of brake fluid through fluid delivery device 22 into fluid reservoir device 24, especially when blending valve 26 is closed. Second check valve 30 can be designed in particular for a second opening pressure that is greater than the first opening pressure. The second opening pressure can be, for example, above 3 bar, preferably above 5 bar, in particular can be 6 bar. Second check valve 30 is preferably designed so that the second check valve opens only once the second opening pressure is present at fluid delivery device 22. The brake system is not, however, fixed to the use of second check valve 30 having a specific opening pressure. Check valves already utilized in the context of ESP systems can be used for check valves 28 and 30.

Because the brake system is advantageously equipped with components 22, 24, and 26, the brake pressure in the at least one wheel brake caliper 20 can selectably be held constant, reduced, or increased. Components 22, 24, and 26 thus implement a blending apparatus by which the hydraulic braking torque of the at least one wheel brake caliper 20 can be adapted to a non-hydraulic additional braking torque, for example to a generator braking torque. As discussed in more detail below, components 22, 24, and 26 are particularly suitable for blending in a generator braking torque that varies over time. Be it noted, however, that the usability of components 22, 24, and 26 is not limited to the blending in of a generator braking torque.

The brake system can be advantageously used in particular in a vehicle that, in addition to an internal combustion engine 32, also has a generator (not depicted) for charging a vehicle battery 36. The usability of the brake system is not, however, limited to a vehicle equipped with the generator.

The brake system can also be equipped with an ESP apparatus 38 that is designed to apply control to the high-pressure switching valves, switchover valves, wheel inlet valves, and/or wheel outlet valves (all not depicted) of the at least one brake circuit. The brake system can also be designed for execution of an ABS function. ESP apparatus 38 can encompass a motor 34 and a hydraulic unit 40. Because the embodiment latitude of the brake system is not, however, limited to a specific type of ESP apparatus 38 or of the at least one brake circuit, no further explanation thereof will be given here.

In an advantageous refinement, the brake system has a control device 42 that is designed to apply control to fluid delivery device 22 and/or to blending valve 26 in order to blend in a time-varying non-hydraulic additional braking torque, for example the generator braking torque of the generator. Control apparatus 42 can be connected via lines 44 to the at least one sensor 16, to pump motor 25, to blending valve 26, to the generator, to vehicle battery 36, and/or to ESP apparatus 38. Control apparatus 42 can furthermore execute, in particular, the method steps indicated in more detail below. Reference is therefore made to the Figures that follow regarding the design of control apparatus 42 and of the method steps executable therewith.

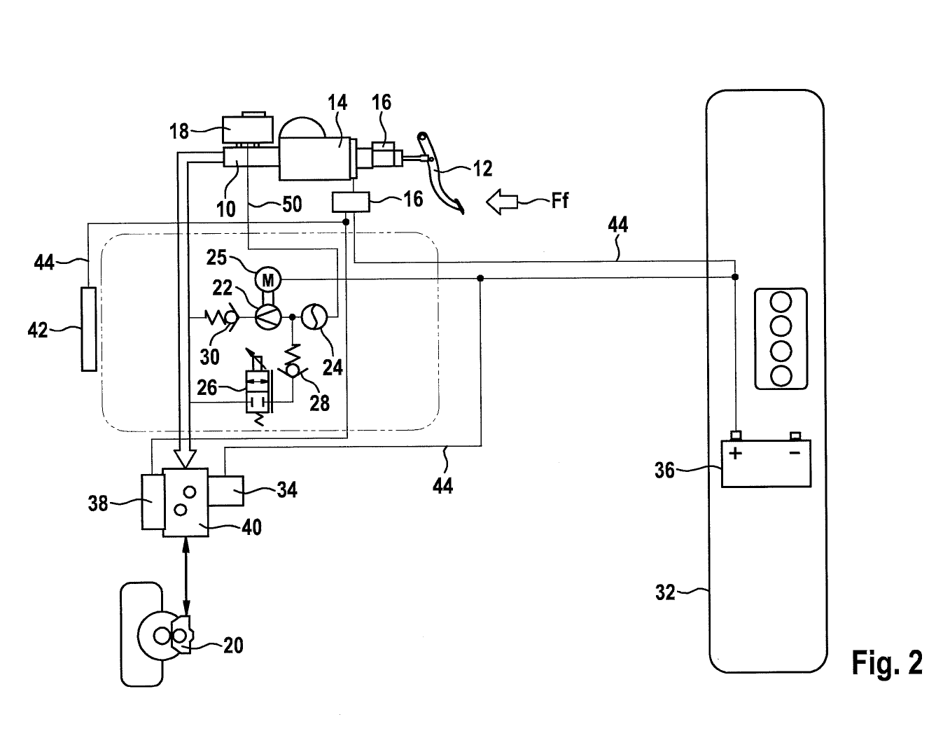

FIG. 2 schematically depicts a second example embodiment of the brake system.

The brake system schematically depicted in FIG. 2 has the components already described above. Those components therefore will not be described again.

As a supplement, in the brake system of FIG. 2 fluid reservoir device 24 is connected via a connecting line 50 to brake fluid reservoir 18. Fluid reservoir device 24, embodied as a reservoir chamber, is preferably connected from its back side to brake fluid reservoir 18. Thanks to the advantageous linkage of fluid reservoir device 24 to brake fluid reservoir 18, upon reception of brake fluid (from the at least one wheel brake caliper), brake fluid is forced, by a displacement of the reservoir piston of fluid reservoir device 24, from the back side of the reservoir piston into brake fluid reservoir 18. Fluid reservoir device 24 connected to brake fluid reservoir 18 can therefore be embodied to be free of counter-pressure.

Because of the advantageous linkage of fluid reservoir device 24 to brake fluid reservoir 18, the seal in the reservoir piston can moreover be impinged upon from both sides with brake fluid. The seal can thus exhibit very low friction. The costs for the seal of fluid reservoir device 24, which can be embodied, e.g., from PTFE, can thus be reduced. The linkage of fluid reservoir device 24 to brake fluid reservoir 18 also allows the brake pressure in the at least one wheel brake caliper 20 to be reduced to a value of (almost) zero.

In a preferred embodiment, fluid reservoir device 24 is a non-gas-preloaded membrane reservoir. It is thereby possible to prevent the occurrence, in the context of pumping of the previously received brake fluid by fluid delivery device 22 into the at least one wheel brake caliper 20, of a negative pressure on the suction side of fluid delivery device 22, thus causing the reservoir piston or reservoir chamber piston to be pulled out to the end stop. The use of the membrane is thus an advantageous capability for reducing or avoiding a preload pressure in fluid reservoir device 24 that is linked to brake fluid reservoir 18. The membrane is preferably designed so that at higher pressures it makes contact against the housing of the reservoir chamber without thereby being damaged or destroyed. Be it noted that the embodiment of the reservoir chamber as a membrane reservoir is advantageous even without the back-side connection to brake fluid reservoir 18, since lubrication in order to reduce the friction of the moving seal is thereby no longer necessary.

Be it noted, however, that the brake system is not limited to a fluid reservoir device 24 embodied as a non-gas-preloaded membrane reservoir. As an alternative to this kind of embodiment of fluid reservoir device 24, the friction of the seal in the context of reservoir piston suction can also be reduced, alternatively to assistance of the piston motion, by installing a weaker spring that permits, for example, a maximum pressure of approximately 1 bar. This allows reliable refilling of the volume on the back side of the reservoir piston from brake fluid reservoir 18. Impingement of the seal with fluid on both sides results in very low friction.

Be it noted that in the context of the exemplifying embodiments presented above, leakage at the seal of fluid reservoir device 24 is excluded.

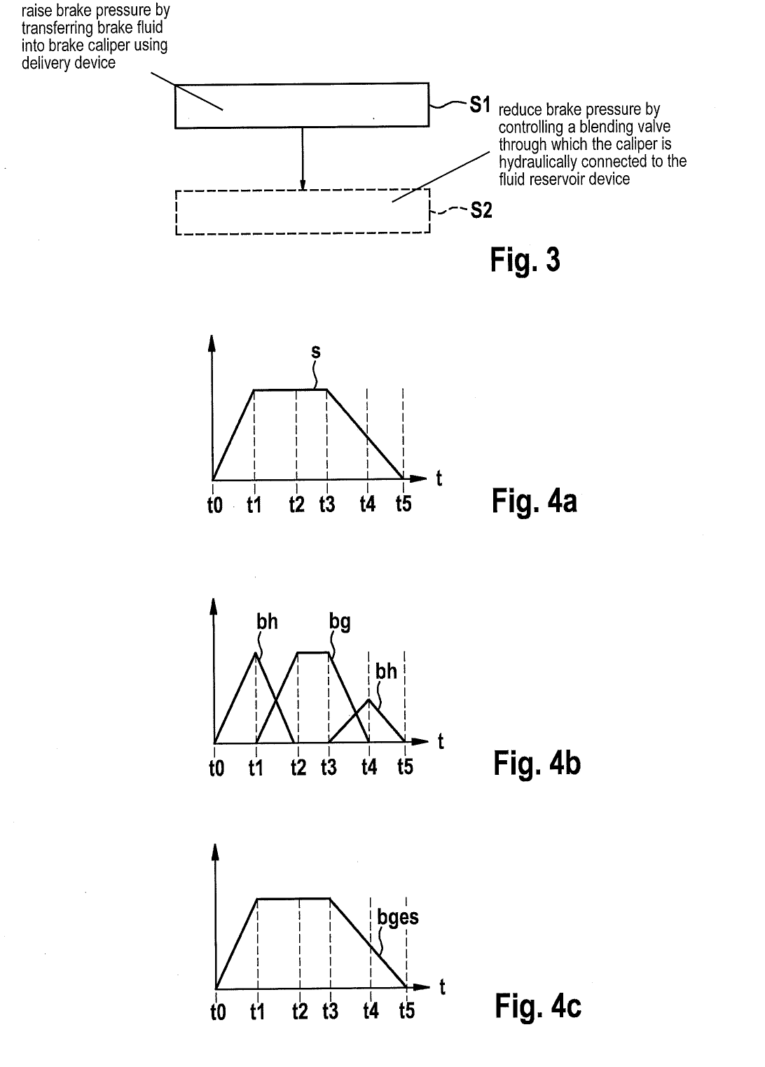

FIG. 3 is a flow chart to depict a first embodiment of an example method for operating a brake system of a vehicle. The example method described below can be implemented, for example, by way of one of the brake systems presented above. The embodiment latitude of the example method is not, however, limited to the use of those brake systems.

In a method step S1, a brake pressure in at least one wheel brake caliper hydraulically connected to a brake master cylinder is raised by transferring brake fluid into the at least one wheel brake caliper using a delivery device. This is done by pumping brake fluid out of a fluid reservoir device into the at least one wheel brake caliper using a substantially uniformly delivering pump device (constituting a fluid delivery device). Brake fluid is preferably pumped into the at least one wheel brake caliper by way of a gear pump or a phase-shifted multi-piston pump.

As a result of the execution of method step S1, the brake pressure in the at least one wheel brake caliper can be raised independently of an internal pressure in the brake master cylinder. The brake pressure can thus also be raised independently of an actuation of a brake actuation element by a driver.

The example method optionally also encompasses a method step S2 in which the brake pressure in the at least one wheel brake caliper is reduced by controlling a blending valve through which the at least one wheel brake caliper is hydraulically connected to the fluid reservoir device. The blending valve is in that context controlled into an at least partly opened state. The result of this is that brake fluid is transferred into the fluid reservoir device via the blending valve that is controlled into the at least partly opened state.

By the use of method step S2, the brake pressure in the at least one wheel brake caliper can be reduced independently of the internal pressure in the brake master cylinder. In particular, the brake pressure in the at least one wheel brake caliper can be held constant or reduced despite an increasing driver braking force that is being exerted on the brake actuation element.

Method steps S1 and S2 can be used in particular to adapt the brake pressure in the at least one wheel brake caliper to a non-hydraulic additional brake torque that varies over time, e.g., in particular to a generator braking torque, varying over time, of a generator. Method step S1 is preferably executed in the context of a decrease over time in the generator braking torque. Conversely, an increase over time in the generator braking torque can be at least partly compensated for by way of method step S2. Method steps S1 and S2 make it possible, in particular, to blend in the time-varying generator braking in such a way that despite the changes over time in the generator braking torque, a target vehicle deceleration stipulated by the driver by actuation of the brake actuation element is reliably complied with.

The designation of method steps S1 and S2 does not specify any chronological sequence for executing them. Method steps S1 and S2 can instead be executed in different chronological sequences, and repeated any number of times.

FIGS. 4a to 4c show three coordinate systems to explain a second embodiment of the method for operating a brake system of a vehicle.

The abscissas of the coordinate systems of FIGS. 4a to 4c are the time axis t. The ordinate of FIG. 4a is a pedal travel s. The ordinate of FIG. 4b reproduces a hydraulic braking torque bh of the at least one wheel brake caliper and a generator braking torque bg of a generator. The total deceleration bges exerted overall on the vehicle (sum of the hydraulic braking torque bh and generator braking torque bg) is indicated by the ordinate of FIG. 4c.

One of the brake systems presented above is used by way of example in the method described below. The embodiment latitude of the method described here is not, however, limited to the use of those brake systems.

As long as the driver is not actuating the brake actuation element, the pedal travel s, hydraulic braking torque bh, generator braking torque bg, and total deceleration bges are equal to zero. Starting at time t0, the driver has a braking request and therefore actuates the brake actuation element, and brake fluid is forced out of the brake master cylinder. Because the blending valve is in its closed state, brake fluid is displaced only into the at least one wheel brake caliper, so that a brake pressure builds up therein. This produces an increase in the hydraulic braking torque bh corresponding to the increase in pedal travel s. As long as the generator is not activated, the generator braking torque bg remains equal to zero, and the total deceleration bges corresponds to the hydraulic braking torque bh.

Starting at time t1, the blending valve is controlled into an at least partly opened state. Controlling the blending valve into the at least partly opened state produces a displacement of brake fluid out of the at least one wheel brake caliper, through the at least partly opened blending valve, optionally via the first check valve, into the fluid reservoir device. (The first check valve does not suppress this, provided the first opening pressure of the first check valve is less than the brake pressure present in the at least one wheel brake caliper.) The brake pressure in the at least one wheel brake caliper can thereby be reduced, and the hydraulic braking torque bh therefore decreases starting at time t1.

Starting at time t1, the generator can be activated in such a way that the generator braking torque bg increases in accordance with the decrease over time in the hydraulic braking torque bh. The total deceleration bges can thus correspond to the pedal travel s despite an increase over time in the generator braking torque bg. Starting at time t2, the generator torque bg can be equal to the total deceleration bges. Thanks to the increased generator braking torque bg, the vehicle battery can be recharged quickly.

As is evident from FIGS. 4a to 4c, even in the context of a constant pedal travel s not equal to zero, the brake pressure in the at least one wheel brake caliper can be reduced (almost) to zero. The hydraulic braking torque bh of the at least one wheel brake caliper can correspondingly also be reduced to zero. The target deceleration of the vehicle stipulated by the driver by way of the pedal travel s can thus be implemented exclusively by way of the generator braking torque bg. This ensures quick recharging of the vehicle battery that can be recharged by the generator.

Starting at time t3, the driver reduces the driver braking force exerted on the brake actuation element. For example, the driver takes his or her foot off the pedal. Starting at time t3, control is therefore applied to the generator in such a way that the generator braking torque bg decreases starting at time t3. The decrease in the generator braking torque bg can also be faster than the decrease, stipulated by the driver, in the target deceleration of the vehicle. To ensure nevertheless that the total deceleration bges corresponds to the pedal travel s, starting at time t3 a hydraulic braking torque bh not equal to zero can be applied by the at least one wheel brake caliper. This can be implemented by the fact that brake fluid is pumped, by the fluid delivery device embodied as a substantially uniformly delivering pump device (gear pump or a phase-shifted multi-piston pump), out of the fluid reservoir device into the at least one wheel brake caliper, and a brake pressure not equal to zero is thus built up therein. This can be accomplished in particular by the fact that the sum of the hydraulic braking torque bh and the generator braking torque bg yields a total deceleration corresponding to the pedal travel s.

Be it noted that thanks to the pumping of brake fluid out of the fluid reservoir device into the at least one wheel brake caliper by the substantially uniformly delivering pump device (gear pump or phase-shifted multi-piston pump), a decrease over time in the generator braking torque bg can be compensated for even in the context of a pedal travel s that remains constant or is increasing. It is possible, for example, to compensate in this way for the absence of usability of the generator because a vehicle battery is completely charged, or for deceleration of the vehicle below a speed suitable for use of the generator.

Starting at time t4, the generator braking torque bg is reduced to zero. Starting at time t4, the total deceleration bges of the vehicle is thus applied exclusively by way of the hydraulic braking torque bh of the at least one wheel brake caliper. After closure of the blending valve, the hydraulic braking torque bh adapts automatically to the decreasing pedal travel s. This ensures that at time t5, when the pedal travel is again equal to zero, the hydraulic braking torque bh and the total deceleration bges are also equal to zero.

1-12. (canceled)

13. A brake system for a vehicle, comprising:
a brake master cylinder that is hydraulically connected to at least one wheel brake caliper;
an ESP apparatus that encompasses a hydraulic unit and a motor; and
an additional fluid delivery device by which brake fluid is transferable into the at least one wheel brake caliper, the fluid delivery device being embodied as a substantially uniformly delivering pump device by which brake fluid is pumpable out of a fluid reservoir device into the at least one wheel brake caliper.

14. The brake system as recited in claim 13, wherein the fluid delivery device is embodied as a one of: i) gear pump, or ii) a phase-shifted multi-piston pump.

15. The brake system as recited in claim 13, wherein the at least one wheel brake caliper is hydraulically connected via a blending valve to the fluid reservoir device in such a way that brake fluid is transferable into the fluid reservoir device via the blending valve that is controlled into an at least partly opened state.

16. The brake system as recited in claim 15, further comprising:
a first check valve disposed between the blending valve and the fluid reservoir device.

17. The brake system as recited in claim 16, wherein a delivery side of the fluid delivery device is hydraulically connected to the at least one wheel brake caliper via a second check valve.

18. The brake system as recited in claim 13, wherein the fluid delivery device is embodied as an internal gear pump.

19. The brake system as recited in claim 13, wherein the fluid delivery device is a springless reservoir chamber.

20. The brake system as recited in claim 13, wherein the fluid delivery device is connected via a connecting line to a brake fluid reservoir.

21. The brake system as recited in claim 13, wherein the fluid reservoir device is a non-gas-preloaded membrane reservoir.

22. A method for operating a brake system of a vehicle, comprising:
increasing a brake pressure in at least one wheel brake caliper hydraulically connected to a brake master cylinder by transferring brake fluid into the at least one wheel brake caliper, the brake fluid being transferred by pumping the brake fluid out of a fluid reservoir device into the at least one wheel brake caliper using a substantially uniformly delivering pump device that is embodied as a fluid delivery device in addition to an ESP apparatus encompassing a hydraulic unit and a motor.

23. The method as recited in claim 22, wherein the brake fluid is pumped out of the fluid reservoir device into the at least one wheel brake caliper using one of: i) a gear pump, or ii) a phase-shifted multi-piston pump.

24. The method as recited in claim 23, further comprising:
reducing the brake pressure in the at least one wheel brake caliper by controlling a blending valve through which the at least one wheel brake caliper is hydraulically connected to the fluid reservoir device into an at least partly opened state, with the result that brake fluid becomes transferred into the fluid reservoir device through the blending valve that is controlled into the at least partly opened state.
